(19) United States
(12) Patent Application Publication
(10) Pub. No.: US 2003/0086661 A1
(43) Pub. Date: May 8, 2003

(54) Silicon waferboard

(76) Inventors: Robert A. Boudreau, Corning, NY (US); Songsheng Tan, Corning, NY (US)

Correspondence Address: CORNING INCORPORATED, SP-TI-3-1, CORNING, NY, 14831

(21) Appl. No.: 10/016,113

(22) Filed: Nov. 2, 2001

(51) Int. Cl. G02B 6/42

(52) U.S. Cl. 385/88; 385/137

(57) ABSTRACT

An optical receiver module includes a silicon wafer defining opposed first and second surfaces and having a transverse opening through the silicon wafer. The opening has at least two generally planar surfaces which intersect to form a V-shaped registration comer. An optical detector is secured to the first surface of the silicon wafer adjacent the opening, and an optical fiber has an end portion positioned within the transverse opening. The optical fiber has an outer surface in contact with the generally planar surfaces to position the end portion of the optical fiber within the opening. A fiber holder includes a pair of silicon chips, each having a V-groove. The optical fiber is positioned in the V-grooves and sandwiched between the silicon chips. The silicon chips are secured to the silicon wafer to retain the optical fiber.

### BACKGROUND OF THE INVENTION

1. Field of the Invention

The present invention relates to silicon waferboards that may be utilized to passively align optical, optoelectronic and/or electrical components with a high degree of accuracy to ensure proper operation of the components. Technical Background

2. “Silicon Optical Bench” (SiOB) technology has been utilized for the packaging of optical components, such as optical receiver modules. An existing, prior art SiOB optical receiver module 1 (FIG. 1) includes a silicon waferboard 7 having one or more V-grooves 2. One or more optical fibers 3 are placed in the V-grooves deep enough to be buried under the surface 10 of the silicon waferboard 7, but spaced above the root 2a of V-grooves 2 in contact with sidewalls 2b of V-grooves 2. The light 4 exiting from the optical fiber 3 is reflected by the front sidewall 9 of the V-grooves 2, and then illuminates the active area 8 of the optical detector 6. Solder 5 is utilized to secure the detector to the silicon waferboard 7. In this example, the distance from the exit point of the optical fiber 3 to the active area 8 of the detector 6 is more than 150 μm, so that the light spot size will become at least 20 μm due to the divergence of the light when exiting the single mode optical fiber 3. However, when operating frequency is increased, the diameter of the active areas of detectors becomes smaller, and may be only 10 μm, for example, for 40 GHz pin detectors. Existing receiver modules, such as the SiOB unit illustrated in FIG. 1, may not therefore, provide enough light intensity for proper operation of the module.

Another known arrangement is a method to place an optical fiber near a device and includes a substrate and a passive alignment member. The top surface of the substrate has a first V-groove for holding an optical fiber, and a second saw groove is used for placing the passive alignment member. However, such an arrangement has several limitations, such as the difficulty in forming the second saw groove. Furthermore, the electric metallization of the structure is not compatible with high frequency operation.

### SUMMARY OF THE INVENTION

One aspect of the present invention is an optical receiver module including a silicon wafer defining opposed first and second surfaces and having a transverse opening through the silicon wafer. The opening has at least two generally planar surfaces forming a V-shaped registration comer. An optical detector is secured to the first surface of the silicon wafer adjacent the opening, and an optical fiber has an end portion positioned within the transverse opening. The optical fiber has an outer surface in contact with the generally planar surfaces to position the end portion of the optical fiber within the opening. A fiber holder includes a pair of silicon chips, each having a V-groove. The optical fiber is positioned in the V-grooves and sandwiched between the silicon chips. The silicon chips are secured to the silicon wafer to retain the optical fiber.

Another aspect of the present invention is an optical device including a wafer defining opposed first and second surfaces and having a transverse opening through the wafer, the opening having at least one registration surface. An optical device is secured to the first surface of the wafer adjacent to the opening. An optical fiber has an end portion positioned within the transverse opening, and the optical fiber has an outer surface in contact with the registration surface to position the end portion of the optical fiber within the opening.

Another aspect of the present invention is a method of fabricating an optical receiver module. The method includes providing a wafer having first and second sides and an opening therethrough. An optical receiver is secured to the first side of the wafer, and an end of an optical fiber is positioned in the opening in optical communication with the optical receiver such that at least a portion of a light signal traveling along the optical fiber will strike the optical receiver.

Additional features and advantages of the invention will be set forth in the detailed description which follows and will be apparent to those skilled in the art from the description or recognized by practicing the invention as described in the description which follows together with the claims and appended drawings.

It is to be understood that the foregoing description is exemplary of the invention only and is intended to provide an overview for the understanding of the nature and character of the invention as it is defined by the claims. The accompanying drawings are included to provide a further understanding of the invention and are incorporated and constitute part of this specification. The drawings illustrate various features and embodiments of the invention which, together with their description serve to explain the principals and operation of the invention.

### BRIEF DESCRIPTION OF THE DRAWINGS

FIG. 1 is a partially schematic, side elevational view of a prior art SiOB receiver;

FIG. 2 is a partially fragmentary, side elevational view of an optical device according to one aspect of the present invention;

FIG. 3 is an end view of a silicon wafer of the optical device of FIG. 2;

FIG. 4 is an end view of the silicon wafer of FIG. 3 illustrating the alignment of the optical fiber in the diamond shaped hole through the silicon wafer;

FIG. 5 is a side elevational view of the fiber holder of the optical device of FIG. 2;

FIG. 6 is an end view of the fiber holder of FIG. 5.

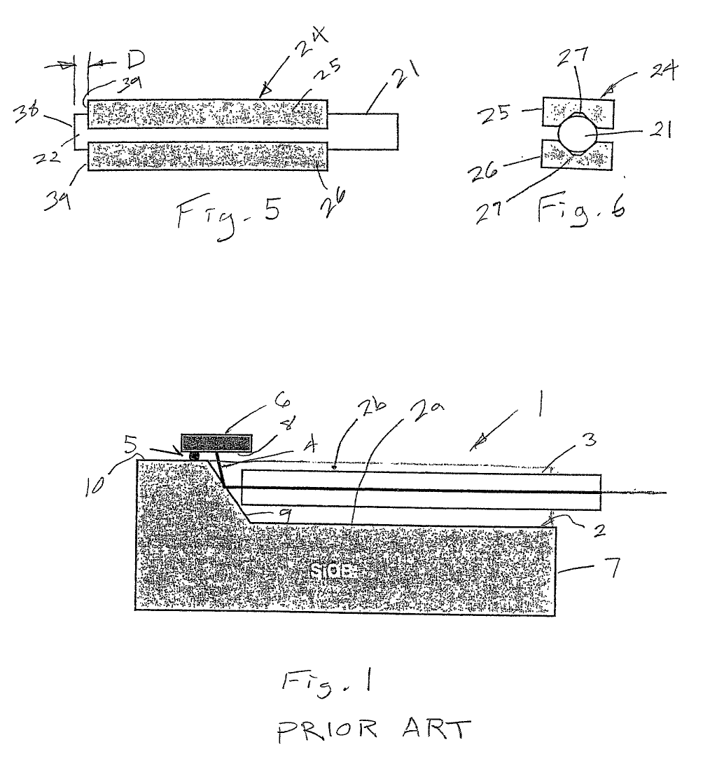

### DETAILED DESCRIPTION OF THE PREFERRED EMBODIMENT

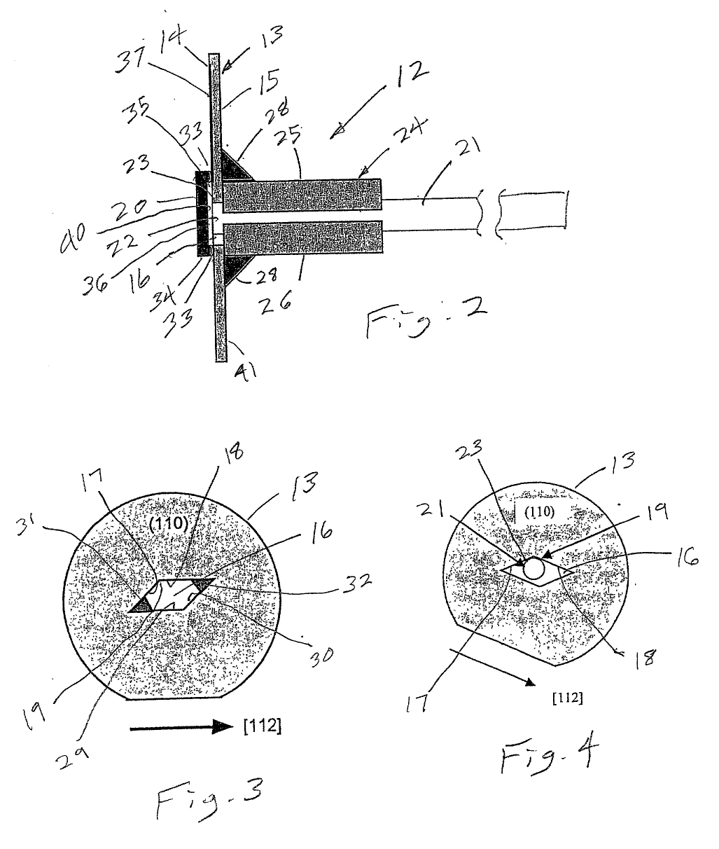

An optical device such as optical receiver module 12 (FIG. 2) includes a silicon wafer 13 defining opposed first and second surfaces 14 and 15, respectively. A transverse opening 16 (see also FIG. 3) through the silicon wafer 13 includes at least two generally planar surfaces 17 and 18 forming, at their intersection, a V-shaped registration corner 19. An optical device such as an optical detector 20 (FIG. 2) is secured to the first surface 14 of the silicon wafer 13 adjacent and in alignment with the opening 16. An optical fiber 21 has an end 22 positioned within the transverse opening 16. The optical fiber 21 includes an outer surface 23 (see also FIG. 4) in contact with the planar surfaces 17 and 18 to position the end 22 of the optical fiber 21 within the opening 16. A fiber holder 24 includes a pair of silicon chips 25 and 26. Each of the silicon chips 25 and 26 include a V-groove 27 (see also FIG. 6). The optical fiber 21 is positioned in the V-grooves 27 and sandwiched between the silicon chips 25 and 26. The silicon chips 25 and 26 are secured to the silicon wafer 13 via solder 28 (FIG. 2) to retain the optical fiber 21.

Silicon wafer 13 is a (110) Si wafer plate having a [112] crystal orientation as shown in FIG. 3. The transverse opening 16 has a diamond shape with the sidewall surfaces 17, 18, 29, and 30 aligned with the crystal orientation of <112>. The opening 16 is formed by an isotropic etching of the (110) silicon wafer, such that the opening 16 is bounded by {111} planes, which are transverse to the first and second surfaces 14 and 15 of the (110) wafer 13. The etching follows the crystal planes, such that the angles between the two sets of {111} planes are about 70.5° and about 109.5°. Two tilted {111} planes 31 and 32 initially form around the 70.5° comers, such that over-etching is utilized to clean the registration comer 19 to eliminate the tilted {111} plane. Suitable etching processes are well known to those skilled in the art, such that the etching process will not be described in detail herein. The optical detector chip 20 is mounted on the surface 14 of the (110) silicon waferboard 13 utilizing known “flip chip” solder bonding techniques. The position of the detector chip 20 is passively aligned relative to the diamond-shaped hole 16 utilizing conventional pedestals 33 on the first surface 14 of the silicon wafer 13. The side surface 34 of the detector chip 20 is registered to the pedestals 33. Conventional metallization pads 35 and solder 36 under the detector chip 20 provide an electrical connection to the electric metallization pattern 37 on the first surface 14 of silicon wafer 13. The electric metallization pattern 37 is formed via known masking techniques and provides electrical connection points for electrically connecting the optical receiver module 12 to other components of the system.

With reference to FIGS. 5 and 6, silicon chips 25 and 26 each have a V-groove 27 that is formed via conventional etching techniques. In the illustrated example, the end surface 38 of optical fiber 21 protrudes a distance “D” of about 450 μm out from the end surfaces 39 of the silicon chips 25 and 26. The end surface 38 of fiber 21 may be treated utilizing known techniques to form a lense surface as required. The distance “D” is slightly less than the thickness of the silicon wafer 13 such that the end surface 38 of the optical fiber 21 is precisely positioned to create a very small gap between the end surface 38 of fiber 21 and the active area of the optical detector chip 20 when assembled. In a preferred embodiment, the silicon wafer 13 has a thickness of about 550 μm, such that the end surface 38 of optical fiber 21 is positioned about 10 μm away from the active area 40 of optical detector chip 20. The distance D may be varied as required for a particular application to provide the required gap relative to the optical detector chip.

During assembly of the optical receiver module 12, the silicon chips 25 and 26 are first secured to the optical fiber 21 via U.V. curable adhesive, solder or other suitable adhesive. The optical fiber 21 is then inserted into the diamond-shaped opening 16 from the backside 41 (FIG. 2). One of the comers, such as comer 19, is assigned as a registration comer during the design of the silicon wafer 13. When assembled (see also FIG. 4), the outer surface 23 of optical fiber 21 contacts the planar surfaces 17 and 18 of the registration comer 19 such that the optical fiber 21 is passively aligned relative to the wafer 13 with a high degree of accuracy. Suitable passive alignment equipment and techniques for positioning the optical fiber 21 in contact with planar surfaces 17 and 18 are known in the art. For example, gravity or spring-generated forces may be utilized to hold the fiber 21 in contact with surfaces 17 and 18, and also to maintain contact between the end surfaces 39 of silicon chips 25, 26 and second surface 15 of silicon wafer 13 during the soldering process that secures the fiber 21 to the silicon wafer 13. When the end surfaces 39 of the silicon chips 25 and 26 are brought into contact with the second surface 15 of the silicon wafer 13, the end portion 22 of fiber optic line 21 extends into the diamond-shaped opening 16, with the end surface 38 of the optical fiber 21 positioned slightly below the first surface 14 of the silicon wafer 13. The fiber holder 24 is secured to the silicon wafer 13 via solder 28 or other suitable adhesive to form the assembled optical receiver module 12.

The present invention permits very precise location of the end of an optical fiber relative to an optical device such as an optical detector or emitter. Because the end of the optical fiber can be placed very close to the detector, the travel distance of the light after exiting the fiber is reduced, thus reducing the light spot size. Precise positioning of the fiber end very close to the receiver chip permits very high frequency operation of receiver modules. Also, the passive mechanical alignment of the fiber relative to the receiver chip alleviates the problems associated with active alignment techniques wherein the receiver chip is activated during assembly to position the fiber. Although an optical detector is shown in the illustrated example, the present invention may also be utilized to passively align other types of optical devices such as an emitter. Also, the present invention encompasses alignment of a lens element to the end of an optical fiber. This lens element can either be a refractive optic, a diffactive optic, or an optical filter.

It will become apparent to those skilled in the art that various modifications to the preferred embodiment of the invention as described herein can be made without departing from the spirit or scope of the invention as defined by the appended claims.

The invention claimed is:

1. An optical receiver module, comprising:
a silicon wafer defining opposed first and second surfaces and having a transverse opening through said silicon wafer, said opening having at least two generally planar surfaces which intersect to form a V-shaped registration comer;
an optical detector secured to said first surface of said silicon wafer adjacent and in alignment with said opening;
an optical fiber having an end positioned within said transverse opening, said optical fiber having an outer surface in contact with said generally planar surfaces to position said end portion of said optical fiber within said opening;
a fiber holder including a pair of silicon chips, each having a V-groove, said optical fiber positioned in said V-grooves and sandwiched between said silicon chips, said silicon chips secured to said silicon wafer to retain said optical fiber with respect to said wafer.

2. The optical receiver module of claim 1, wherein:
said opening is generally diamond shaped.

3. The optical receiver module of claim 2, wherein:
said opening forms four comers, two of said comers forming angles of about 70.5 degrees, and two of said comers forming angles of about 109.5 degrees.

4. The optical receiver module of claim 1, wherein:
said silicon wafer includes an electrically conductive material disposed on said first surface operably connected with said optical detector.

5. The optical receiver module of claim 1, wherein:
said silicon wafer includes pedestals extending from said first surface, said optical detector contacting said pedestals to thereby position said optical detector.

6. The optical receiver module of claim 1, wherein:
said silicon chips of said fiber holder are secured to said silicon wafer by solder.

7. An optical device, comprising:
a wafer defining opposed first and second surfaces and having a transverse opening through said wafer, said opening having at least one registration surface;
an optical device secured to said first surface of said wafer adjacent said opening;
an optical fiber having an end positioned within said transverse opening, said optical fiber having an outer surface in contact with said registration surface to position said end of said optical fiber within said opening.

8. The optical device of claim 7, wherein:
said wafer is made of a silicon material.

9. The optical device of claim 7, including:
a fiber holder having a groove that receives said optical fiber, said fiber holder secured to said wafer.

10. The optical device of claim 7, including:
a fiber holder having a pair of silicon chips, each having a V-groove, said optical fiber positioned in said V-grooves and sandwiched between said silicon chips, said silicon chips secured to said silicon wafer.

11. The optical device of claim 8, wherein:
said silicon material defines a [112] crystal orientation, said opening having a side surface aligned with said [112] crystal orientation.

12. The optical device of claim 11, wherein:
said opening is diamond shaped.

13. The optical device of claim 12, wherein:
said silicon wafer has a conductive material disposed on said first surface that is electrically connected to said optical detector.

14. The optical device of claim 13, wherein:
said optical device comprises an optical detector capable of operation at at least about ten giga bytes per second.

15. A method of fabricating an optical receiver module, comprising:
providing a wafer having first and second sides and an opening therethrough;
securing an optical receiver to said first side of said wafer;
positioning an end of a optical fiber in said opening in optical communication with said optical receiver such that at least a portion of a light signal traveling along said fiber optical fiber will strike said optical receiver.

16. The method of claim 15, including:
providing a fiber holder having a groove;
positioning said fiber optic line in said groove; and
securing said holder to said second side of said wafer.

17. The method of claim 16, wherein:
said wafer is fabricated from silicon; and
said opening has a diamond shape.

18. The method of claim 17, wherein:
said fiber optic line contacts at least two sidewalls of said opening to locate said fiber optic line.

19. The method of claim 19, wherein:
a sidewall of said opening is aligned with a [112] crystal orientation of said wafer.

20. The method of claim 19, wherein:
said opening is formed by anisotropic etching.
